(19) United States
(12) Patent Application Publication
(10) Pub. No.: US 2025/0003837 A1
(43) Pub. Date: Jan. 2, 2025

(54) METHOD FOR POSITIONING A VEHICLE ON A VEHICLE TEST STAND

(71) Applicant: DÜRR ASSEMBLY PRODUCTS GMBH, Püttlingen (DE)

(72) Inventors: Ismail KURT, Völklingen (DE); Timo WALLSCHEID, Schmelz (DE); Michael MORLO, St. Ingbert (DE); Thorsten SCHMIDT, Riegelsberg (DE); Patrik DEGES, Schmelz (DE)

(21) Appl. No.: 18/706,284

(22) PCT Filed: Nov. 8, 2022
(86) PCT No.: PCT/DE2022/100828

§ 371 Date: Apr. 30, 2024

(30) Foreign Application Priority Data
Nov. 15, 2021 (DE) 10 2021 129 687.0

(51) Int. Cl. G01M 17/007

(52) U.S. Cl. CPC G01M 17/0074

(57) ABSTRACT

The present invention relates to a method for positioning a vehicle on a vehicle test stand. The vehicle test stand has wheel receptacles which each have a vertex roll, a double roll or a floating belt. Each wheel or each wheel combination of at least one axle of the vehicle is assigned, on each of the two vehicle sides, a wheel receptacle. In order for tests to be carried out, the wheels of the vehicle stand on the respective wheel receptacles. According to the present invention, the vehicle is assigned a transport means for the vehicle at least at times in the production process. In order to position the wheels of the vehicle assigned to the transport means on the wheel receptacles of the vehicle test stand, the vehicle assigned to the transport means and the wheel receptacles of the vehicle test stand are moved in a movement towards one another which has a direction component in a vertical direction. The mounting of the wheels of the vehicle on the wheel receptacles takes place with a defined contact pressure force between the wheels of the vehicle and the wheel receptacles of the vehicle test stand, which contact pressure force is greater than corresponds to the weight force of the vehicle in the production process, which is carried via the respective wheel.

### FIELD OF THE DISCLOSURE

This disclosure relates to a method for positioning a vehicle on a vehicle test stand according to the preamble of claim 1.

### BACKGROUND

DE 36 41 424 A1 discloses moving a partially mounted vehicle in a production process having a transport means to the individual production stations. The partially mounted vehicle is in this instance raised by the transport means by the partially mounted vehicle being raised at corresponding retention points of the chassis of the vehicle. In the production process, there is also provision to carry out tests on the vehicle by means of a vehicle test stand. The vehicle test stand has a plurality of wheel receiving members so that for each wheel of the vehicle a wheel receiving member is provided. The wheels of the vehicle and the wheel receiving members of the vehicle test stand are orientated with respect to each other in such a manner that a wheel receiving member is located below each wheel of the vehicle. To this end, the vehicle is raised by a corresponding distance by the transport means. The wheel receiving members of the vehicle test stand are where applicable still adjusted in terms of their spacing with respect to each other with respect to the wheel base and the track width of the vehicle. The vehicle is then moved by the transport means in such a manner that, when the vehicle is lowered, each wheel of the vehicle rests on one of the wheel receiving members. The vehicle is lowered to such an extent that the vehicle is supported with its weight completely via the wheels and the wheel receiving members. The provided travel tests are then carried out. After the travel tests are completed, the vehicle is positioned in the vehicle test stand again in such a manner that the retention elements of the transport means engage on the provided retention points of the chassis again when the vehicle is raised. When the travel test are carried out, it may be the case that the position of the vehicle on the wheel receiving members changes in a lateral direction. Before the vehicle is raised by the transport means, this lateral offset of the vehicle has to be reversed again.

### SUMMARY

It is known to provide a vehicle test stand at the line end during vehicle production.

This vehicle test stand at the line end generally has wheel receiving members, wherein a wheel receiving member is associated with each wheel or each wheel combination of each axle of the vehicle at each of the two vehicle sides.

Vehicle test stands are also known, in which a wheel receiving member is associated with each wheel or each wheel combination of precisely one axle of the vehicle at each of the two vehicle sides. These are, for example, brake/roller test stands in which the brake forces of the wheels of the axles of a vehicle are verified by the vehicle standing one after the other with the wheels of the different axles on the wheel receiving members of the vehicle test stand.

The “wheel combination” relates to vehicles, which have so-called “twin wheels” on one or more axles in each case at both sides of the vehicle. These twin wheels are then used when a significant axial load occurs on an axle. The weight loading on this axle is then distributed at each side of the corresponding axle over two wheels. For the tests, the two twin wheels can be treated uniformly as one wheel. Consequently, these twin wheels also have a common wheel receiving member.

The wheel receiving members in each case have a top roller, a dual roller or a floating belt.

With a top roller, the wheel stands on a single roller. Since this position is only stable in a limited manner, the vehicle has to be additionally fixed in position. This may, for example, be carried out by so-called support rollers which bear in the travel direction of the wheel in front of and behind the wheel on the tire and hold the wheel (and consequently also the vehicle) in the position in which the respective vehicle wheel rests on the top roller being provided. Other retention elements may also be provided which grip and retain the vehicle or components of the vehicle or against which components of the vehicle (for example, the bumpers) bear in order to prevent a movement of the vehicle at least in one direction.

Embodiments of wheel receiving members with dual rollers are also known. The respective vehicle wheel then touches both rollers when it stands on the wheel receiving member. The vehicle wheel falls between the two rollers of the wheel receiving member. A stable position for the vehicle wheel is thereby defined. The further the rollers are apart, the deeper the respective wheel of the vehicle falls between the two rollers. As a result of the lowering, the stability of the vehicle position is improved. In this instance, it should be taken into account that the vehicle has only a limited ground clearance. The vehicle must only fall so far that the underbody does not stand on the rollers or other components of the test stand. It is known, before the vehicle is driven out from a test stand with wheel receiving members which are in the form of dual rollers, to move together these dual rollers to a minimum spacing with respect to each other in a motorized manner. The vehicle is thereby raised so that driving out of the wheel receiving member is facilitated. Alternatively, it is also known to configure the wheel receiving member with a lifting plate. In this instance, between the two rollers of the wheel receiving member a lifting plate by means of which the respective vehicle wheel is raised is moved upward. Driving out of the test stand is also thereby facilitated. Alternatively, the wheel receiving members can also be moved for wheels of a plurality of axles of the vehicle with respect to the wheel stand between the wheel receiving members in the longitudinal vehicle direction. At least the wheels of one axle can thereby be moved into coverage. In a test stand with wheel receiving members only for the wheels or wheel combinations of one axle of the vehicle, no measures are required. In this instance, the vehicle can thus also drive out of the test stand.

After the vehicle has been driven into the vehicle test stand or the described lowering of the vehicle in DE 36 41 424 A1, the wheels of the axles of the vehicle to be tested stand on the respective wheel receiving member in order to carry out tests.

These tests may relate to the functions of different vehicle systems. For the function tests, the vehicle wheels are driven or braked by the vehicle itself or by the wheel receiving members. In order to evaluate the functionality, measurement values are detected by measurement systems. These measurement values may, for example, be the speed or forces or torques which occur. For example, on boards or screens objects or sequences for calibrating or functionally verifying vehicle-side cameras or vehicle-side systems for vehicle support or in the field of autonomous driving can also be displayed.

For calibration or function verification of vehicle-side radar or lidar systems and vehicle-side systems which evaluate such sensor signals, corresponding reflectors or simulators may also be arranged around the vehicle. The vehicle test stand may be configured in such a manner that, by means of the vehicle test stand, journeys of the vehicle (where applicable also including steering movements) can be simulated.

The vehicle is in the subject-matter of examples disclosed herein in the production process at least temporarily associated with a transport means.

These transport means are used if the vehicle is intended to be transported from one station to the next during production (in a partially mounted or fully mounted state). Furthermore, these transport means are used to retain the vehicle, particularly when the wheels of the vehicle are not yet mounted so that the vehicle cannot yet stand on the ground.

These transport means may be carrier structures on which the vehicle is supported in a suspended manner in a hanger. Such a transport means is, for example, described in the patent application DE 103 36 399 A1. This relates to “vehicle receiving members of an overhead track”. In terms of terminology, in the present protective right, in the case of a vehicle transport by means of an overhead track the “carrier structure” corresponds to the “vehicle receiving member”. By means of movement of the carrier structure, the vehicle is also moved.

The vehicle is not necessarily associated with a transport means during the entire production process. The transport means may change during the production process. Furthermore, the vehicle can be moved without transport means in the production process when the wheels are mounted and the vehicle is further provided with the necessary units.

These transport means may also be self-driving carriers (DE 36 41 424 A1) on which the completely mounted or partially mounted vehicle is placed. As a result of a movement of the self-driving carrier, the vehicle can be moved in the production process. These self-driving carriers are also referred to as (“AGV” (Automated Guided

Vehicle) or “FTS” (“Führerloses Transportsystem” or driverless transport system).

The vehicle and the wheel receiving members of the test stand are moved toward each other in a movement in a vertical direction in examples disclosed herein in order to position the wheels of the vehicle on the wheel receiving members of the vehicle test stand.

As a result of this movement, the wheels of the vehicle are connected to the respective wheel receiving member in a non-positive-locking manner, The non-positive-locking connection means in this instance that the drive or braking forces interact between the vehicle wheel and the respective wheel receiving member.

An object of examples disclosed herein is to configure the production process in a more flexible manner.

According to examples disclosed herein, the support of the wheels of the vehicle on the wheel receiving members is carried out with a defined pressing force between the wheels of the vehicle and the wheel receiving members of the vehicle test stand. This defined pressing force between the wheels of the vehicle and the wheel receiving members of the vehicle test stand is greater than corresponds to the weight of the vehicle in the production process which is discharged via the respective wheel.

This has the advantage that, even with a vehicle which is only partially mounted in the vehicle test stand, there can be simulated the loads on the individual wheels which correspond to the weights, which are intended to be discharged via the respective wheels, of the fully mounted vehicle. Other weights which are greater than the weight of the vehicle when, for example, the travel behavior in different load states is intended to be simulated, can also be simulated. Another advantage may involve the vehicle being supported with the respective wheels safely on the wheel receiving members without the reaction forces during dynamic travel tests leading to the wheels of the vehicle lifting off the wheel receiving members. In a brake test stand, the pressing force may result in a friction force which permits a specific braking force without the tire skidding being produced.

The pressing force can be produced by there being fitted to the vehicle test stand at least one vehicle holding-down member which engages on the vehicle and in this instance pulls the vehicle onto the vehicle test stand. This vehicle holding-down member may engage on the vehicle in one or more suitable positions, such as, for example, on the underbody, on the sill, on one or both bumpers, in the region of the front end or the back end of the vehicle.

This pressing force can also be produced by the vehicle not only being placed on the wheel receiving members, but in addition being pressed downward. This may, for example, be carried out by means of the carrier structure of the vehicle when the vehicle is retained and transported by means of the carrier structure in the hanger. In this instance, the carrier structure is pressed downward with a defined force-and consequently also the vehicle which is secured in the carrier structure. Generally, this can be carried out by the portion of the transport means which holds the vehicle being lowered. The vehicle can be fixed in the transport means and the transport means can be pressed or pulled downward with a defined force.

It is thereby possible to produce on the wheel receiving members contact forces of the vehicle which are greater than corresponds to the weights of the (where applicable at this time only partially mounted) vehicle. In the exemplary embodiments described in this instance, the retention member of the vehicle can to this end be lowered on the self-driving carrier or the carrier structure of the vehicle in the hanger can be lowered.

If, during the relative movement of the vehicle and the wheel receiving members, only the vehicle is moved, this has the advantage that the vehicle test stand with the calibrated measurement devices is not changed.

These embodiments relate to a movement sequence in which the vehicle is lowered so that the wheels of the vehicle stand on the wheel receiving members.

A weight loading of the individual wheels of the vehicle can also be simulated when the vehicle is fixed in position at least with respect to a movement in a vertical direction and the vehicle test stand is on the whole provided with a lifting device or each of the wheel receiving members is provided individually with a lifting device. The fixing of the vehicle can be carried out by the vehicle being securely connected to the transport means and the transport means itself being fixed at least with respect to a movement in a vertical direction. In this embodiment, the vehicle test stand as a whole or the wheel receiving members individually is/are raised in order to position the wheels of the vehicle on the wheel receiving members. The fixing of the vehicle counter to a movement in a vertical direction is in the context described in this instance significant for the possibility of being able to adjust a defined pressing force. As a result of individually raising the individual wheel receiving members (where applicable also with different lifting forces—as explained in connection with claim 6), an individual weight loading of the individual vehicle wheels can be simulated. As an alternative to this embodiment, for example, a common lifting unit may also be provided for the wheel receiving members of the vehicle test stand for the wheels of an axle. It is also possible to provide a common lifting unit for all the wheel receiving members of the vehicle test stand.

The relative movement of the vehicle and the wheel receiving members of the vehicle test stand in a vertical direction toward each other can accordingly be carried out by the wheel receiving members of the test stand being moved toward the vehicle. This lifting movement may be driven in a motorized, pneumatic and/oy hydraulic manner. Advantageously, the test stand is thus not completely lifted, but only the wheel receiving members.

In order to carry out the tests in the vehicle test stand, the vehicle can be fixed horizontally and vertically relative to the vehicle test stand. This can be carried out via the wheel receiving members, the transport means or a fixing unit which fixes the vehicle at a suitable location. Such locations are, for example, underbody, sill, bumper or components on the front or back end of the vehicle.

The connection for non-positive-locking interaction of the wheel receiving members of the vehicle test stand with the corresponding wheels of the vehicle can be carried out using the following method steps.

In preparation, the vehicle test stand and the vehicle can be orientated relative to each other in the horizontal plane in such a manner that, during the subsequent relative movement of the wheel receiving members and the vehicle in a vertical direction, the wheels of the axle(s) of the vehicle which is/are intended to be tested are connected with a non-positive-locking interaction with the respective wheel receiving members.

Alternatively, it is also possible to carry out the positioning of the wheel receiving members of the vehicle test stand relative to the associated wheels of the vehicle in the horizontal plane in a synchronous manner with the relative movement in a vertical direction of the wheel receiving members and the associated wheels of the vehicle. That is to say, the horizontal movement and the vertical movement are then carried out at the same time. The vehicle is conveyed or retained by the transport means. The relative movement of the wheel receiving members of the vehicle test stand and the associated wheels of the vehicle has a component in a vertical direction.

To this end, the vehicle test stand may be displaceable in the horizontal plane so that the vehicle test stand in the horizontal plane is positioned below the vehicle in such a manner that the wheel receiving members are located below the respective wheels of the vehicle.

Alternatively or additionally to this movement of the vehicle test stand, the vehicle can also be moved by the transport means in such a manner that the wheels of the vehicle are located in the horizontal plane above the respective wheel receiving member of the vehicle test stand.

It is advantageous when the vehicle test stand per se is not moved. That is to say, the vehicle is orientated in the horizontal plane toward the vehicle test stand. The measurement device, display elements (screens, sensors) of the vehicle test stand may remain fixed in position and do not also have to be moved and where applicable be newly calibrated with respect to the coordinate system of the vehicle test stand. Structurally, it is also not a problem to move the vehicle in the horizontal plane.

To this end, the vehicle in known production lines is already arranged on the carrier structure of a hanger or on a self-driving carrier.

In the embodiment according to claim 1, the vehicle can be pressed relative to the wheel receiving members in such a manner that the pressing force is controlled.

In the embodiment of the method according to claim 2, the support of the wheels of the vehicle is carried out on the wheel receiving members with a defined spacing between the fender edge and the wheel center.

Consequently, the—where applicable only partially mounted—vehicle is pressed or pulled downward with a defined force. This defined force corresponds to the deflection path of the vehicle suspension in such a manner that the defined spacing is adjusted between the fender edge and the wheel center.

In the method according to claim 2, the wheels of the vehicle consequently stand on the wheel receiving members with a defined pressing force. The spacing between the fender edge and the wheel center (also referred to as the “height level” of the vehicle) represents a comparatively simple-to-measure guiding variable for the control of the pressing force between the wheels of the vehicle and the respective wheel receiving members.

The defined spacing between the fender edge and the wheel center may, for example, be the construction position “KO” which is predetermined by the vehicle construction.

The interactive connection with non-positive-locking of the vehicle wheels with the respective wheel receiving members of the vehicle test stand can be carried out both with a stopped transport means and with moving transport means and a moving vehicle test stand. The movement of the transport means in this instance means that the transport means is moved onward with the vehicle (and the then moving vehicle test stand) in a horizontal direction.

In the configuration according to claim 3, the vehicle test stand is constructed in such a manner that a wheel receiving member is associated with each wheel or each wheel combination of each axle of the vehicle at each of the two vehicle sides. Furthermore, the positions of the wheel receiving members of the vehicle test stand can be adjusted relative to each other in the horizontal plane in order to adapt to the wheel base of the vehicle which is intended to be tested.

This is found to be advantageous when different vehicle types are produced in a production line. The vehicles of a vehicle type have the same wheel base. The wheel base may be different between different vehicle types. The wheel base relates to the spacing between the axles of a vehicle in the longitudinal direction of the vehicle.

Claim 4 relates to an embodiment of the method in which the vehicle test stand is constructed in such a manner that a wheel receiving member is associated with each wheel or each wheel combination of precisely one axle of the vehicle at each of the two vehicle sides. Furthermore, in this instance the positions of the wheel receiving members of the vehicle test stand can be adjusted relative to the vehicle in the longitudinal direction of the vehicle which is intended to be tested in such a manner that the wheel receiving members are associated one after the other with different axles of the vehicle.

The configuration of the vehicle test stand as a single-axle test stand has the advantage that the test stand on the whole has fewer components. As a result of a corresponding positioning of the wheel receiving members one after the other in the longitudinal vehicle direction in such a manner that the wheels of different axles are positioned one after the other on the wheel receiving members, all the wheels of the vehicle can nonetheless be subjected to the tests.

Although the entire test time period is extended with respect to a test stand in which all the wheels of the vehicle stand at the same time on a wheel receiving member of the vehicle test stand, in connection with examples disclosed herein this extension of the cycle time is subordinate since it is possible to carry out the tests whilst other operations are carried out in parallel during the production process on the vehicle which is associated with the transport means.

In the embodiment according to claim 5, the positions of the wheel receiving members of the vehicle test stand can be adjusted relative to each other in the horizontal plane for adaptation to the track widths of the axles of the vehicle which is intended to be tested.

The different vehicle types may have different track widths. This can be compensated for within specific limits by the rollers of the wheel receiving members being correspondingly long. It may thereby be possible for the wheels of the axles of a vehicle to stand on the respective wheel receiving member even when the vehicle types have different track widths. Advantageously, the vehicle test stand may also be configured in such a manner that the lateral spacings of the wheel receiving member can be adjusted relative to each other for adaptation to the track width(s) of the vehicle which is intended to be tested. The track widths on the axles of a vehicle may further be different.

In the embodiment of the method according to claim 6, the vehicle is securely held with respect to a position change in a vertical direction. The movement component of the individual vehicle wheels and the associated wheel receiving members relative to each other in the vertical direction involves a lifting movement of the wheel receiving members. The lifting forces of the individual wheel receiving members are adjusted individually.

The individual adjustment of the lifting forces of the individual wheel receiving members includes the lifting forces of all the receiving members being raised with identical lifting forces. In this instance, a grouping of the wheel receiving members may also be carried out in the sense that the wheel receiving members of an axle of the vehicle or the wheel receiving members of the right or left side of the vehicle are raised in each case with identical lifting forces. Some examples of this are explained below.

Consequently, with a partially mounted vehicle, the weight distribution on the individual axles or also the individual wheels can be simulated when in the further production process additional accessories are mounted on or in the vehicle. Depending on the weight thereof and the installation location in the vehicle, the weight loading of the individual wheels of the vehicle can thereby change differently.

The driving behavior of the vehicle in travel mode can consequently advantageously be simulated in a more complete manner with regard to a pitch angle and/or rolling angle (roll angle) which occurs during dynamic travel.

In order to simulate a pitch movement in a vehicle having two axles, the lifting forces of the wheel receiving members of the wheels of an axle of the vehicle are adjusted differently from the lifting forces of the wheel receiving members of the wheels of the other axle of the vehicle.

For the simulation of a rolling movement of a vehicle, the lifting forces of the wheel receiving members of the wheels of a vehicle side are adjusted differently from the lifting forces of the wheel receiving members of the wheels of the other axle of the vehicle.

As long as the vehicle has an adaptive suspension in which the forces in the suspension with respect to each wheel change in such a manner that the orientation of the vehicle in the horizontal plane remains constant (guiding variables of the control of the suspension of the vehicle are in this case a pitch angle of 0° and a rolling angle (roll angle) of) 0°, as a result of changing lifting forces on the individual wheel receiving members forces can be introduced into the suspension of the vehicle and simulate an (initial) pitch movement or a rolling movement of the vehicle. During correct operation, the adjustment of the control variables of the suspension of the vehicle must with a correct function of the adaptive suspension be such that an initial pitch or rolling movement is already recognized and is compensated for by the adjustment of the control variables. In the case of changing lifting forces of the wheel receiving members, a function test of the adaptive suspension may involve the disturbance variables which are introduced being compensated for in such a manner that the orientation of the vehicle remains unchanged in the horizontal plane.

With such an adaptive suspension, a regulatory objective also involves on a “bumpy road” with corresponding occurrences of unevenness or potholes, not only keeping the orientation of the vehicle in the horizontal plane constant but instead adjusting the resilient forces on the individual wheels in such a manner that each wheel is pressed at all times with an optimum contact force on the ground. The compliance with this regulatory objective can also be verified by the lifting forces of the individual wheel receiving members being adjusted differently with respect to each other one after the other.

### BRIEF DESCRIPTION OF THE DRAWINGS

An exemplary embodiment of examples disclosed herein is illustrated in the drawings, in which:

FIG. 1: shows a schematic drawing of a vehicle test stand, in which the wheel receiving members are provided with lifting devices,

FIG. 2: shows an embodiment of the vehicle test stand according to FIG. 1 with wheel receiving members which are in the form of top rollers,

FIG. 3: shows an embodiment of the vehicle test stand according to FIG. 1 with wheel receiving members which are in the form of dual rollers, and

FIG. 4: shows an embodiment of the vehicle test stand according to FIG. 1 with wheel receiving members of which the two wheel receiving members for the wheels of the rear axle are in the form of top rollers and of which the two wheel receiving members for the wheels of the front axle are in the form of dual rollers.

### DETAILED DESCRIPTION

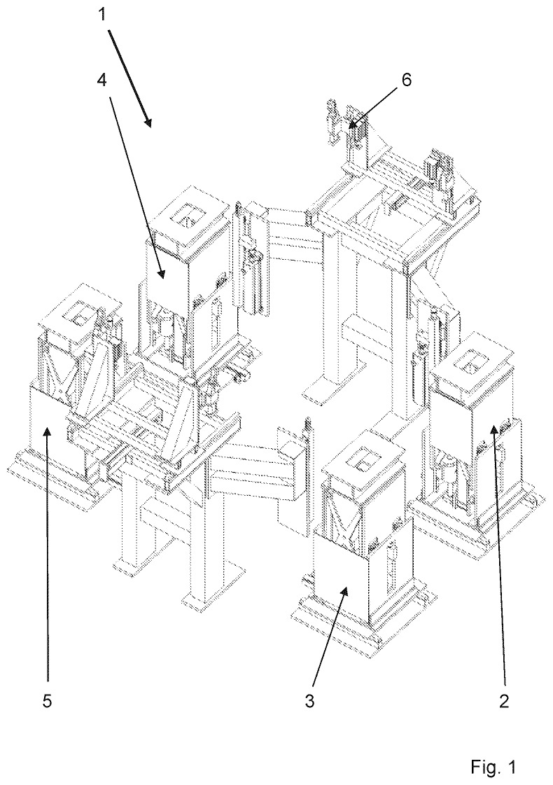

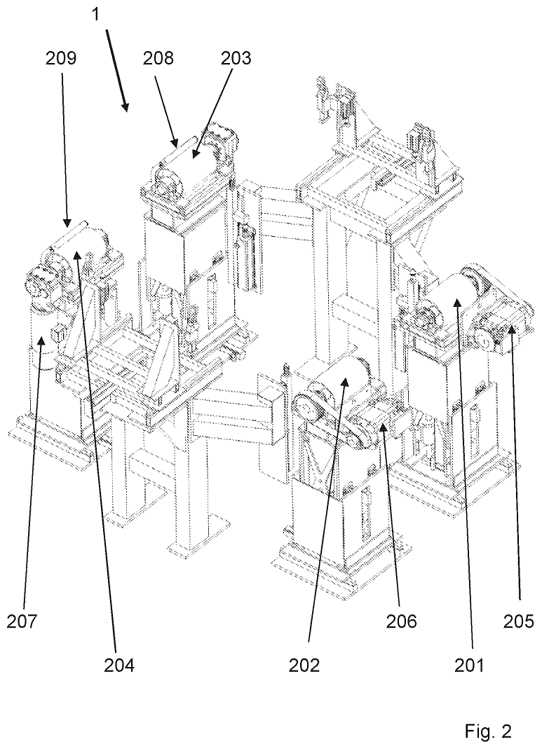

FIG. 1 shows a schematic drawing of a vehicle test stand 1 in which the wheel receiving members are provided with lifting devices 2, 3, 4, 5. It is thereby possible—depending on the orientation of the vehicle test stand 1 relative to the vehicle in a horizontal direction—for the wheel receiving members to be raised in the direction of the vehicle which is arranged above. In the illustration of FIG. 1, the wheel receiving members themselves are not depicted. The vehicle test stand with wheel receiving members is shown in FIGS. 2 to 4.

In FIG. 1, the lifting devices 2 and 3 for the wheels of the rear axle are indicated as are the lifting devices 4 and 5 for the wheels of the front axle.

The vehicle test stand may be constructed in such a manner that, in order to adapt to the wheel base of the vehicle, the spacing between the lifting devices 2 and 4 and the spacing between the lifting devices 3 and 5 can be adjusted. The spacings between the lifting devices 2 and 4 and the lifting devices 3 and 5 are adjusted in a synchronized manner.

There may also be provision for the spacing between the lifting devices 2 and 3 and the spacing between the lifting devices 4 and 5 to be able to be adjusted. These spacings can advantageously be adjusted independently of each other. Consequently, the vehicle test stand can then also be adapted for vehicles which have different track widths at the front axle and the rear axle.

FIG. 1 illustrates on the vehicle test stand another clamping element 6 which acts as a holding-down member for the vehicle. Consequently, the vehicle can be pressed onto the vehicle test stand. The corresponding advantages are set out in connection with the explanations relating to the claims.

FIG. 2 shows an embodiment of the vehicle test stand according to FIG. 1 with wheel receiving members which are in the form of top rollers 201, 202, 203, 204.

The top rollers 201 and 202 for the wheels of the rear axle of the vehicle are associated with drive motors 205 and 206.

The top rollers 203 and 204 for the wheels of the front axle of the vehicle are associated with drive motors, of which only the drive motor 207 of the top roller 204 is provided with a reference numeral.

The drive motor 207 (and also the drive motor of the top roller 203 without a reference numeral) serve not only to drive the top rollers 203 and 204 in the circumferential direction thereof, but also to adjust a steering angle for the front wheels of the vehicle. To this end, these top rollers can be rotated about a vertical axis.

In order to stabilize the vehicle on the top rollers—in particular also during steering movements of the top rollers 203 and 204—start-up rollers 208 and 209 are provided for the front wheels of the vehicle.

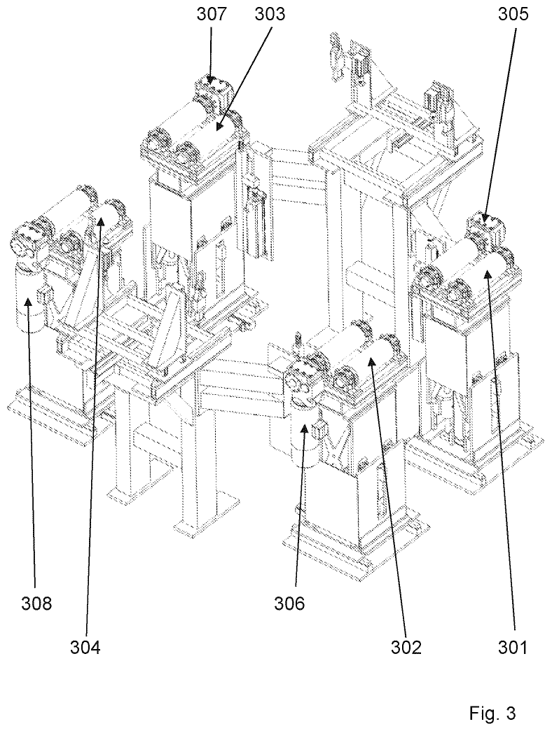

FIG. 3 shows an embodiment of the vehicle test stand according to FIG. 1 with wheel receiving members which are in the form of dual rollers 301, 302, 303, 304. There are associated with the individual dual rollers 301, 302, 303, 304 drive units 305, 306, 307, 308 via which at least one roller of each dual roller can be driven. Furthermore, at least with the drive units 307 and 208 the associated wheel receiving member 303, 304 can be rotated about an axle which is orientated perpendicularly. Steering movements can thereby be simulated again.

Since the wheels of the vehicle stand in a stable state in the dual rollers 301, 302, 303, 304, in this instance none of the start-up rollers 208, 209 from the illustration of FIG. 2 are required.

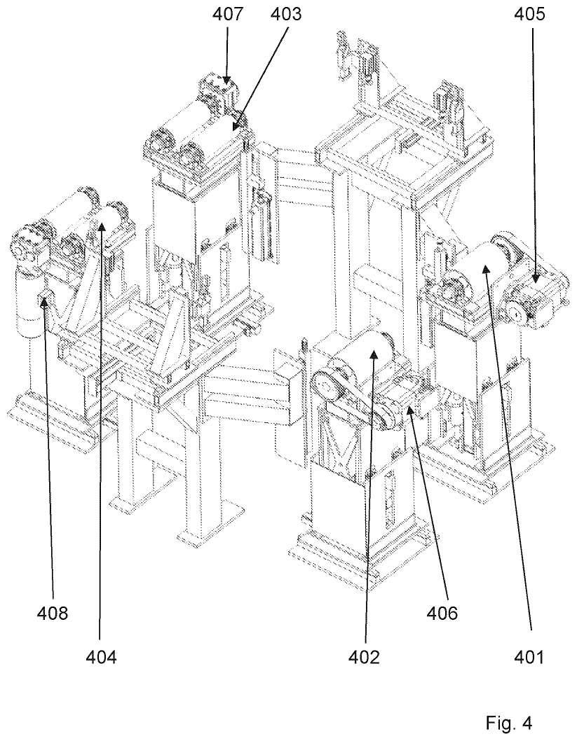

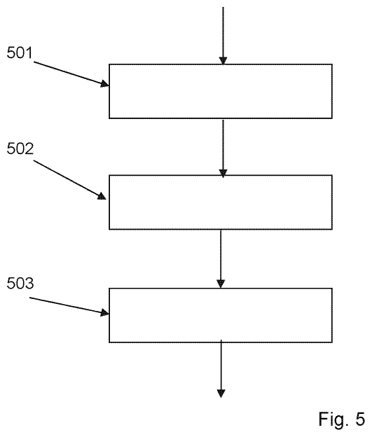

FIG. 4 shows an embodiment of the vehicle test stand according to FIG. 1 with wheel receiving members 401, 402, 403, 403 of which the two wheel receiving members 401, 402 for the wheels of the rear axle are in the form of top rollers and of which the two wheel receiving members 403, 404 for the wheels of the front axle are in the form of dual rollers.

The drive elements 405, 406, 407, 408 can be seen again, by means of which the rollers of the wheel receiving members 401, 402, 403, 403 can be driven (in the case of a dual roller accordingly at least one of the two rollers can be driven).

The dual rollers 403 and 404 can again be rotated about a perpendicular axis in order to simulate steering movements of the vehicle.

FIG. 5 shows a flow chart for the method.

In step 501, the vehicle test stand and the vehicle are orientated with respect to each other in the horizontal plane. In this instance, where applicable, the spacings of the wheel receiving members of the vehicle test stand are further adjusted to the wheel base of the vehicle which is intended to be examined and the track width(s) of the vehicle which is intended to be examined.

In step 502, the wheels of the vehicle and the wheel receiving members are brought into a non-positive-locking interaction. This is carried out by means of a movement of the wheel receiving members and the associated wheels in a vertical direction. A clamping element which may be present is closed.

The steps 501 and 502 do not necessarily have to be carried out one after the other. The horizontal movement and the vertical movement can also be carried out at the same time.

In step 503, function tests, measurements and adjustment operations are carried out.

After the operations in step 503 are completed, in step 504 the wheel receiving members of the vehicle test stand are uncoupled from the wheels of the vehicle again. A clamping element which may be present is released again.

In step 503, all the operations which are already known in connection with other test stands can be carried out again.

These possible examinations also include a transposition test of the speed sensors on the wheels of the vehicle. The wheels may in this instance be driven by means of the driven rollers of the individual wheel receiving members. This can be carried out one after the other. Consequently, it can be determined whether the “correct” speed sensor is providing a signal. In order to shorten the cycle time for this test, the wheels can be driven at different speeds (for example, at 5, 10, 15 and 20 km/h). Consequently, it can be checked whether the individual speed sensors each provide the correct measurement value.

The possible examination also includes a transposition test of the brake valves. To this end, the rollers of the wheel receiving members can be driven in such a manner that different drive torques on the individual rollers are adjusted in order to brake the wheels of the vehicle. It can then be verified whether the wheels of the vehicle rotate in each case at the anticipated speed. In this instance, the different drive torques of the rollers can be adjusted and distributed in such a manner that the yawing moment of the vehicle is minimized. As a result of the clamping device, the vehicle can be fixed on the test stand. Particularly with such tests, the advantage 10 of examples disclosed herein becomes evident as the secure clamping of the vehicle so that the vehicle does not leave the vehicle test stand in an uncontrolled manner.

1. A method comprising: positioning a vehicle on a vehicle test stand (1),
wherein the vehicle test stand (10) has wheel receiving members
wherein a wheel receiving member is associated with each wheel or wheel combination of at least one axle of the vehicle at each of the two vehicle sides,
wherein the wheel receiving members each have a top roller, a dual roller or a floating band,
wherein the wheels of the vehicle to carry out tests stand on the respective wheel receiving member,
wherein the vehicle in the production process is at least temporarily associated with a transport for the vehicle,
wherein the vehicle which is associated with the transport means and the wheel receiving members of the vehicle test stand to position the respective wheels of the vehicle which is associated with the transport means on the wheel receiving members of the vehicle test stand are moved in a movement toward each other, wherein this movement has a direction component in a vertical direction, and
wherein the support of the wheels of the vehicle on the wheel receiving members is carried out with a defined pressing force between the wheels of the vehicle and the wheel receiving members of the vehicle test stand, which is greater than corresponds to the weight of the vehicle in the production process which is discharged via the respective wheel.

2. The method as claimed in claim 1,
wherein
the support of the wheels of the vehicle is carried out on the wheel receiving members with a defined spacing between the fender edge and the wheel center.

3. The method as claimed in claim 1,
wherein
the vehicle test stand is constructed in such a manner that a wheel receiving member is associated with each wheel or each wheel combination of each axle of the vehicle at each of the two vehicle sides, and
in that the positions of the wheel receiving members of the vehicle test stand can be adjusted is adjustable relative to each other in the horizontal plane in order to adapt to the wheel base of the vehicle which is intended to be tested.

4. The method as claimed in claim 1,
wherein
the vehicle test stand is constructed in such a manner that a wheel receiving member is associated with each wheel or each wheel combination of precisely one axle of the vehicle at each of the two vehicle sides, and
in that the positions of the wheel receiving members of the vehicle test stand can be adjusted relative to the vehicle in the longitudinal direction of the vehicle which is intended to be tested in such a manner that the wheel receiving members are associated one after the other with different axles of the vehicle.

5. The method as claimed in claims 2,
wherein
the positions of the wheel receiving members of the vehicle test stand can be adjusted relative to each other in the horizontal plane for adaptation to the track widths of the axles of the vehicle (9501) which is intended to be tested.

6. The method as claimed in claim 1,
wherein
the vehicle is securely held with respect to a position change in a vertical direction,
in that the movement component of the individual vehicle wheels and the associated wheel receiving members relative to each other in the vertical direction involves a lifting movement of the wheel receiving members, and
in that the lifting forces of the individual wheel receiving members are adjusted individually.
